(19) United States
(12) Patent Application Publication
(10) Pub. No.: US 2003/0206777 A1
(43) Pub. Date: Nov. 6, 2003

(54) Metal cutting insert having straight cutting edge and curved abutment surface

(76) Inventor: Ulf Stefan Gyllengahm, Fair Lawn, NJ (US)

Correspondence Address: Ronald L. Grudziecki, Esq., BURNS, DOANE, SWECKER & MATHIS, L.L.P., P.O. Box 1404, Alexandria, VA, 22313-1404, US

(21) Appl. No.: 10/137,684

(22) Filed: May 3, 2002

(51) Int. Cl. B26D 1/00; B26D 3/00; B23P 15/28

(52) U.S. Cl. 407/102

(57) ABSTRACT

A metal cutting insert for the chip-forming cutting (e.g., grooving) of metal workpieces includes a body having a top surface, a bottom surface, and a side surface interconnecting the top and bottom surfaces. A front end of the insert forms a straight cutting edge, and a rear end of the insert forms a convexly curved abutment surface which abuts a concavely curved support surface of a holder. The abutment surface and the support surface have equal radii. The bottom surface of the insert comprises a V-shaped tongue which fits within a V-shaped groove of the holder. The side surface includes a front portion that forms an acute angle with the top surface, and a pair of intermediate portions that are convergent in a direction away from the cutting edge.

### BACKGROUND OF THE INVENTION

The present invention relates to a chip-forming insert used for cutting metal workpieces, especially for grooving, turning and facing operations.

Conventional numerically controlled (CNC) metal cutting machine tools employ a variety of differently shaped cutting inserts and holders shaped to support respective ones of the inserts. One commonly used turning insert is a circular insert which includes a circular cutting edge.

A conventional round cutting insert 10 is depicted in FIGS. 1 and 2, the insert including a circular top surface 12, a side surface 16 which forms a clearance surface, and a pair of downwardly converging, parallel bevels 14 in the side surface 16 so that the insert has a generally V-shaped bottom surface. The insert 10 is mounted in a narrow neck or plate 20 of a holder 22. The neck 20 includes a base portion 24 that forms a seat in the form of a V-shaped groove 26 into which the V-shaped tongue defined by the bottom surface of the insert is placed. A rear end of the insert is supported by an upright support surface 28 which has a circular arc shape with a radius R corresponding to the radius of the circular curvature of the insert. A clamp 30 is securable to the neck by a screw 32 to engage the top surface 12 of the insert and thereby secure the insert in place. The holder 22 also includes a rearwardly projecting mounting portion 34 of any suitable size and shape, and an optional nozzle 36 for emitting a stream of cooling fluid toward the insert.

Such an insert/holder combination can be used, for example, for cutting grooves in metal workpieces. Although the use of round ceramic grooving inserts has produced good productivity when cutting grooves, it has also resulted in the corners of the groove's side walls being rounded rather than sharply angled, necessitating that the corners be cleaned up by a differently shaped insert. That, in turn, means that another holder must be provided which has an insert seat shaped correspondingly to the cleaning-up insert. The need for another holder ties up another tool station of the machine tool, i.e., a station that the machine tool owner might prefer for a different use.

It would be desirable to provide a metal cuffing insert which avoids the above shortcomings and yet which does not require the need for a new holder.

It would also be beneficial to reduce the cuffing forces that typically result from grooving with round inserts.

### SUMMARY OF THE INVENTION

A metal cutting insert for the chip-forming cutting (e.g., grooving) of metal workpieces comprises a body having a top surface, a bottom surface, and a side surface which interconnects the top and bottom surfaces. The side surface includes a front portion, a rear portion, and two intermediate portions which interconnect the front and rear portions. A junction between the top surface and the front portion defines a cutting edge which is generally straight as viewed in a direction perpendicular to the top surface. The front portion forms an acute angle with the top surface. The intermediate portions are convergent in a direction away from the cutting edge. The bottom surface is generally V-shaped, as defined by a pair of downwardly converging bevels formed in the side surface. At least a substantial part of the rear portion is convexly radiused as viewed in the direction perpendicular to the top surface; and the rear portion merges with both of the intermediate portions.

The invention also pertains to a metal cutting tool which includes a holder that forms an upstanding support surface against which a convexly curved rear portion of a grooving insert abuts. The support surface is concavely radiused with a radius substantially equal to the radius of the rear portion of the insert.

### BRIEF DESCRIPTION OF THE DRAWINGS

The objects and advantages of the invention will become apparent from the following detailed description of a preferred embodiments thereof in connection with the accompanying drawings in which like numerals designate like elements and in which:

FIG. 1 is an exploded perspective view of a prior art holder, and a prior art cutting insert mounted in the holder.

FIG. 2 is a top plan view of the insert of FIG. 1, and a clamp for securing the insert.

FIG. 3 is a top rear perspective view of a cutting insert according to the present invention.

FIG. 4 is a top plan view of the insert of FIG. 3.

FIG. 5 is a view similar to FIG. 1 showing the conventional holder, and the insert according to the present invention.

FIG. 6 is a view similar to FIG. 2 showing the grooving insert according to the present invention being secured by the clamp.

FIG. 7 is a side elevational view of the insert of FIG. 3.

FIG. 8 is a front elevational view of the insert of FIG. 3.

FIG. 9 is a top plan view of a modified insert according to the invention mounted in the holder of FIG. 1.

FIG. 10 is a top plan view of the modified insert mounted in a modified holder.

### DETAILED DESCRIPTION OF PREFERRED EMBODIMENTS OF THE INVENTION

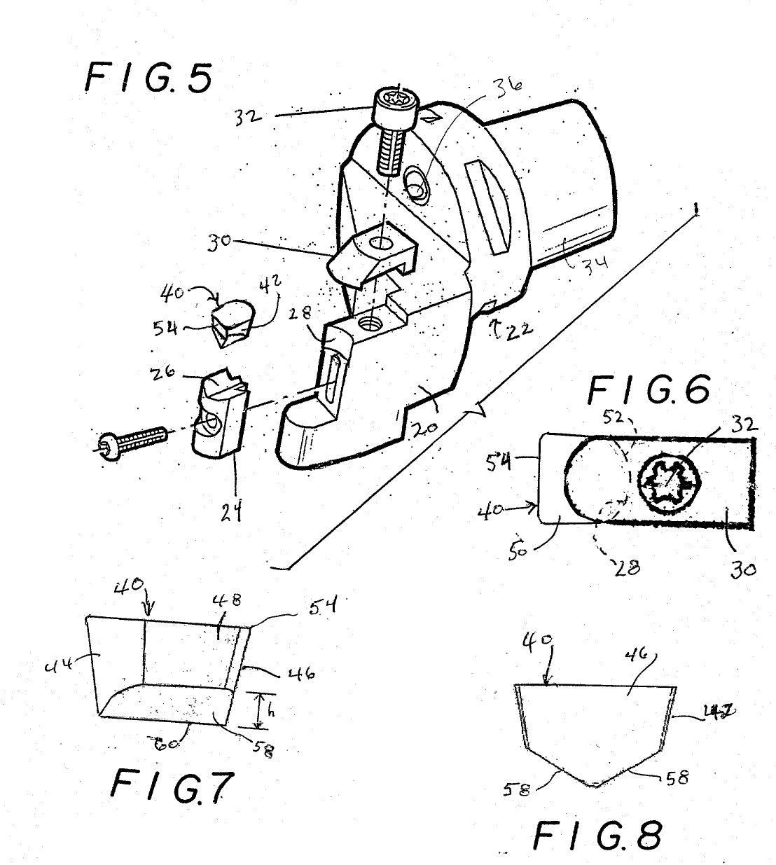

Depicted in FIGS. 3-8 is a metal cutting insert 40 according to the present invention which is capable of use in the above-described conventional holder 22, as can be seen in FIG. 5. The insert includes a side wall 42 which, instead of being round, includes a curved (i.e., radiused) rear portion 44, a flat front portion 46, and two flat intermediate portions 48, each of which interconnects the front and rear portions 46, 44. Accordingly, a top surface 50 of the insert includes a circular arc-shaped rear edge 52 having a radius R, a straight front edge 54, and a pair of straight intermediate edges 56 which are slightly convergent in a direction away from the front edge 54 to form side clearance surfaces.

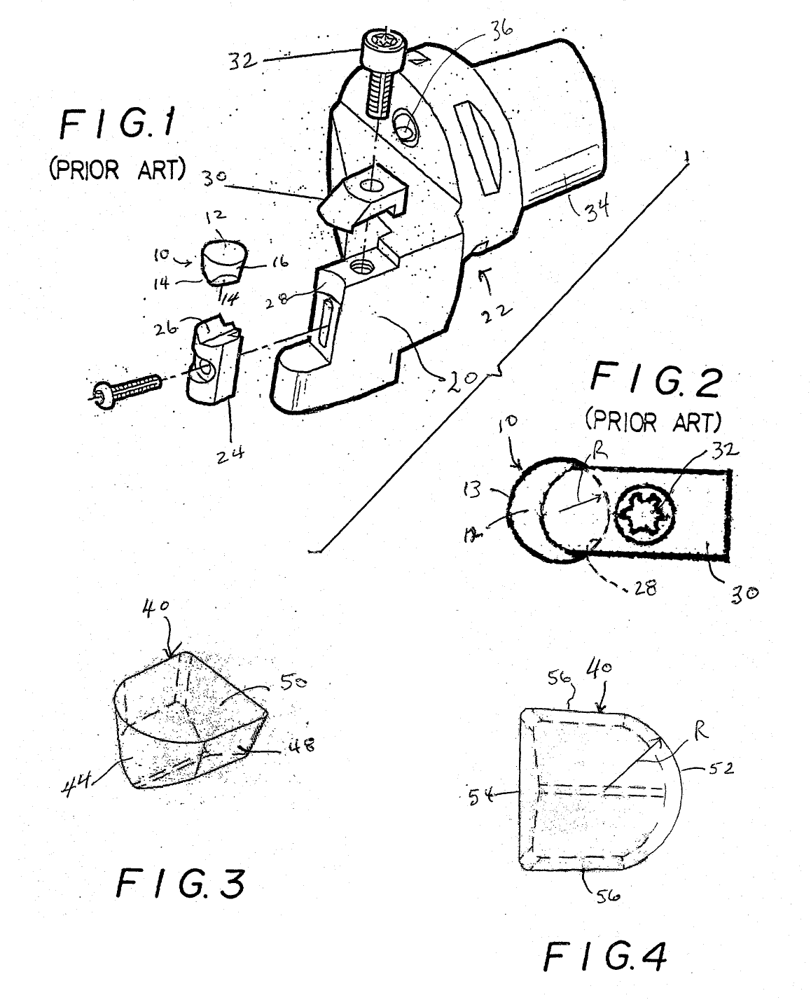

The front edge 54 constitutes a cutting edge, with the front portion 46 of the side surface forming an acute angle with the top surface 50 (see FIG. 7) to constitute a front clearance surface. The rear portion 44 of the side surface constitutes an abutment surface which bears against the upright support surface 28 of the conventional holder 22. Thus, the abutment surface 44 has the same general shape as the side surface of the conventional round insert 10 shown in FIGS. 1-2. That is, the abutment surface 44 is convexly radiused as viewed in a direction perpendicular to the top surface 50. The abutment surface 44 merges with both of the intermediate portions 48 and forms an acute angle with the top surface 50 (see FIG. 7).

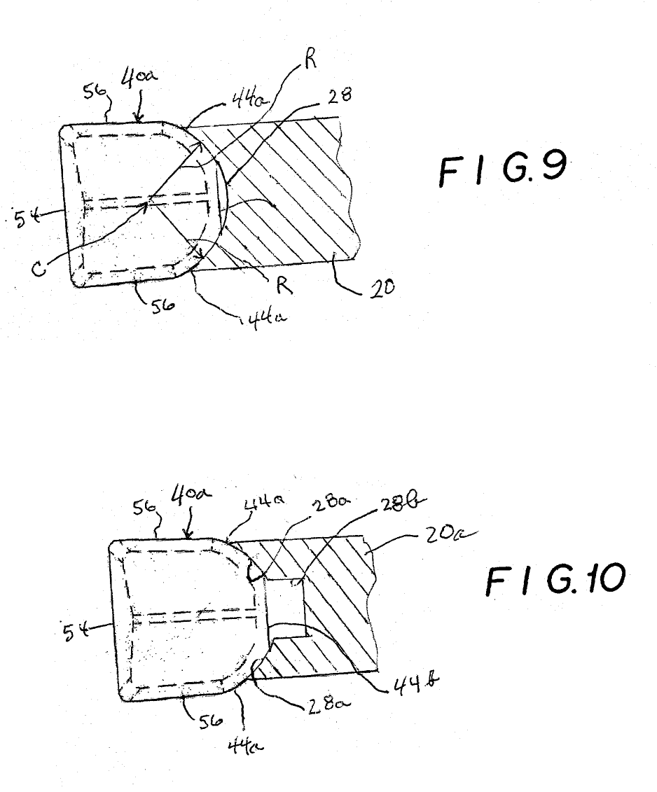

Instead of being continuously radiused between the intermediate portions 48, as shown in FIG. 4, the abutment surface 44 could be truncated, as shown in the insert 40a depicted in FIG. 9, whereby the abutment surface would comprise two convexly radiused arc-shaped portions 44a separated from one another by a flat 44b. The two arc-shaped portions 44a merge with respective ones of the intermediate portions 48 of the side wall. The arc-shaped portions 44a thus have a common center of curvature C and equal radii R. When the insert 40a is mounted in the holder, the arc-shaped portions would abut the support surface 28 of the holder neck 20.

Alternatively, a holder neck 20a shown in FIG. 10 could be provided with a support surface comprised of two concavely radiused sections 28a that are spaced apart by a recess 28b. Such a support surface could support either round inserts 10 (shown in FIG. 2), or the inserts 40, 40a shown in FIGS. 4 and 9, respectively.

The side surface 42 of the insert 40 also includes a pair of downwardly converging bevels 58, whereby the bottom surface of the insert constitutes a generally V-shaped tongue and includes a somewhat rounded bottom edge 60 extending in a front-to-rear direction. Each bevel 58 has a greater height h at its front end than at its rear end.

The insert 40 is installed in the holder by placing its bottom surface into the V-shaped groove 26, such that the bevels 58 contact the downwardly converging surfaces of the groove 26. The radiused rear supporting surface 44 bears against the correspondingly radiused support surface 28. Then, the insert is clamped in place by the clamp 30.

During a metal cutting operation, e.g., grooving, the cutting edge 54 cuts a groove without leaving excessive material in the corners of the groove, thereby avoiding the need for thereafter using an additional insert to clean-up the corners. Also, the length of the cutting edge 54 is less than the length of the cutting edge of the conventional round insert 12, so the overall cutting force is reduced.

The insert can be formed of any suitable hard material, such as a ceramic or cemented carbide.

Although the present invention has been described in connection with a preferred embodiment thereof, it will be appreciated by those skilled in the art that additions, deletions, modifications, and substitutions not specifically described may be made without departing from the spirit and scope of the invention as defined in the appended claims.

What is claimed is:

1. A metal cutting insert for the chip-forming cutting of metal workpieces, comprising a body having a top surface, a bottom surface, and a side surface interconnecting the top and bottom surfaces; the side surface including a front portion, a rear portion, and two intermediate portions interconnecting the front and rear portions; a junction between the top surface and the front portion defining a cutting edge which is generally straight as viewed in a direction perpendicular to the top surface; the front portion forming an acute angle with the top surface; the intermediate portions being convergent in a direction away from the cutting edge; the side surface further including a pair of downwardly converging bevels extending in a front-to-rear direction of the insert, wherein the bottom surface is generally V-shaped; at least a substantial part of the rear portion being convexly radiused as viewed in the direction perpendicular to the top surface; the rear portion merging with both of the intermediate portions.

2. The insert according to claim 1 where each bevel has a greater height at a front end thereof than at a rear end thereof.

3. The insert according to claim 1 wherein the rear portion is continuously radiused between the intermediate portions.

4. The insert according to claim 1 wherein a rearwardmost end of the rear portion is truncated.

5. A metal cutting insert for the chip-forming cutting of metal workpieces, comprising a body having a top surface, a bottom surface, and a side surface interconnecting the top and bottom surfaces; the side surface including a front portion, a rear portion, and two intermediate portions interconnecting the front and rear portions; the front portion forming an acute angle with the top surface; a junction between the top surface and the front portion defining a substantially straight cutting edge; at least a substantial part of the rear portion being convexly radiused as viewed in a direction perpendicular to the top surface; the rear portion merging with both of the intermediate portions; the side surface further including a pair of downwardly converging bevels extending in a front-to-rear direction of the insert, wherein the bottom surface constitutes a generally V-shaped tongue; each bevel having a greater height at a front end thereof than at a rear end thereof; a junction between the top surface and the rear portion of the side surface define a convexly curved rear edge; junctions between the top surface and the two intermediate portions of the side surface defining respective intermediate edges; the intermediate edges interconnecting the rear edge and the cutting edge and being convergent in a direction away from the cutting edge.

6. The insert according to claim 5 wherein the rear edge is continuously radiused between the intermediate edges.

7. The insert according to claim 5 wherein the rear edge is truncated at its rearwardmost end.

8. A metal cutting tool comprising:
a holder including a rear portion defining a mounting portion, and a front portion defining an insert seat and a concavely radiused upstanding support surface situated at a rear end of the seat;
a metal cutting insert for the chip-forming cutting of metal workpieces mounted in the seat, the insert comprising a body having a top surface, a V-shaped bottom surface, and a side surface interconnecting the top and bottom surfaces; the bottom surface resting on the seat; the side surface including a front portion, a rear portion, and two intermediate portions interconnecting the front and rear portions; the front surface forming an acute angle with the top surface; a junction between the top surface and the front portion defining a substantially straight cutting edge; the intermediate portions being convergent in a direction away from the cutting edge; at least a substantial part of the rear portion being convexly radiused as viewed in the direction perpendicular to the top surface, the rear portion merging with both of the intermediate portions; the radius of the rear portion being substantially equal to the radius of support surface wherein the rear portion defines an abutment surface engaging the upright support surface; and
a clamp connected to the holder and pressing downwardly against the top surface.

9. The tool according to claim 8 wherein the rear portion of the insert is continuously radiused between the intermediate portions.

10. The tool according to claim 8 wherein a rearwardmost end of the rear portion is truncated.

11. The tool according to claim 4, wherein the holder includes a nozzle for emitting a stream of cooling fluid toward the insert.
